(19) United States
(12) Patent Application Publication
(10) Pub. No.: US 2026/0279258 A1
(43) Pub. Date: Sep. 17, 2026

(54) ELECTRONIC DEVICE AND METHOD FOR DRIVING ELECTRONIC DEVICE

(71) Applicant: Samsung Display Co., Ltd., Yongin-si (KR)

(72) Inventors: MIN-SEOK BAE, Yongin-si (KR); SeokJeong SONG, Yongin-si (KR); JI-EUN PARK, Yongin-si (KR); KANGHEE LEE, Yongin-si (KR)

(21) Appl. No.: 19/546,572

(22) Filed: Feb. 23, 2026

(30) Foreign Application Priority Data
Mar. 12, 2025 (KR) 10-2025-0032345

(51) Int. Cl. G09G 3/32

(52) U.S. Cl. CPC G09G 3/32; G09G 2320/0257

(57) ABSTRACT

An electronic device may include a display panel and an afterimage compensation unit receiving input image data from an outside and compensating the input image data, and the afterimage compensation unit may include, an afterimage distribution prediction unit receiving a plurality of line data to predict afterimage distribution and generating a first compensation coefficient based on predicted afterimage distribution, an accumulation gain generation unit receiving the input image data to generate a second compensation coefficient, a compensation gain calculation unit receiving the first compensation coefficient and the second compensation coefficient, and generating a third compensation coefficient based on the first compensation coefficient and the second compensation coefficient, and a compensation unit receiving the input image data and the third compensation coefficient, and compensating the input image data by using the third compensation coefficient to generate compensation image data.

### CROSS-REFERENCE TO RELATED APPLICATIONS

This U.S. non-provisional patent application claims priority under 35 U.S.C. § 119 to Korean Patent Application No. 10-2025-0032345, filed on Mar. 12, 2025, the entire contents of which are hereby incorporated by reference.

### BACKGROUND

The present disclosure is related to an electronic device and an electronic device driving method with improved display quality.

Multimedia electronic devices, such as televisions, mobile phones, tablet computers, laptops, navigation, gaming devices, and the like, include a display device for displaying an image. The display device includes a display panel displaying an image and a driving unit. The driving unit includes a gate driver providing gate signals to gate lines, a data driver providing data voltages to data lines, and a driving controller controlling the gate driver and the data driver.

### SUMMARY

The present disclosure provides an electronic device and an electronic device driving method with improved display quality.

An embodiment of the present disclosure provides an electronic device comprising a display panel, and an afterimage compensation unit receiving input image data from an outside and compensating the input image data, the afterimage compensation unit includes an afterimage distribution prediction unit receiving a plurality of line data to predict afterimage distribution and generating a first compensation coefficient based on predicted afterimage distribution, an accumulation gain generation unit receiving the input image data to generate a second compensation coefficient, a compensation gain calculation unit receiving the first compensation coefficient and the second compensation coefficient, and generating a third compensation coefficient based on the first compensation coefficient and the second compensation coefficient, and a compensation unit receiving the input image data and the third compensation coefficient, and compensating the input image data by using the third compensation coefficient to generate compensation image data.

In an embodiment, the plurality of line data are data collected during a manufacturing process.

In an embodiment, the plurality of line data include fabrication line data or module line data.

In an embodiment, the afterimage compensation unit further includes a memory in which the first compensation coefficient is stored.

In an embodiment, the memory is a non-volatile memory.

In an embodiment, the afterimage distribution prediction unit includes a modeling processing unit deriving an afterimage distribution prediction equation based on the plurality of line data and a plurality of afterimage distribution data, and a first gain generation unit receiving the afterimage distribution prediction equation, and generating the first compensation coefficient which is a formalized coefficient generated by using the afterimage distribution prediction equation.

In an embodiment, the modeling processing unit converts the plurality of line data and the plurality of afterimage distribution data into big data.

In an embodiment, the modeling processing unit models the big data to derive the afterimage distribution prediction equation.

In an embodiment, the plurality of afterimage distribution data include information about an afterimage index according to time.

In an embodiment, the afterimage distribution prediction unit further includes a line data storage unit storing the plurality of line data, and an afterimage distribution data storage unit storing the plurality of afterimage distribution data.

In an embodiment, the accumulation gain generation unit includes a data accumulation unit receiving the input image data, and generating accumulation data which includes accumulated stress of the input image data, an accumulation data calculation unit calculating a stress sum value of the accumulation data, and a second gain generation unit generating the second compensation coefficient corresponding to the stress sum value.

In an embodiment, the second gain generation unit generates the second compensation coefficient according to the stress sum value in real time.

An embodiment of the present disclosure provides an electronic device driving method comprising receiving a plurality of line data and predicting afterimage distribution based on the plurality of line data, generating a first compensation coefficient for compensating an afterimage based on predicted afterimage distribution, receiving input image data from an outside and accumulating stress of the input image data, generating a second compensation coefficient for compensating an afterimage due to the accumulated stress, generating a third compensation coefficient based on the first compensation coefficient and the second compensation coefficient, and compensating the input image data by using the third compensation coefficient.

In an embodiment, the electronic device driving method further comprises storing the first compensation coefficient in a memory.

In an embodiment, the predicting the afterimage distribution includes deriving an afterimage distribution prediction equation based on the plurality of line data and a plurality of afterimage distribution data, and receiving the afterimage distribution prediction equation, and generating the first compensation coefficient which is a formalized coefficient generated by using the afterimage distribution prediction equation.

In an embodiment, the deriving the afterimage distribution prediction equation includes converting the plurality of line data and the plurality of afterimage distribution data into big data.

In an embodiment, the deriving the afterimage distribution prediction equation further includes modeling the big data to derive the afterimage distribution prediction equation.

In an embodiment, the plurality of afterimage distribution data include information about an afterimage index according to time.

In an embodiment, the plurality of line data are data collected during a manufacturing process.

An embodiment of the present disclosure provides an electronic device comprising a display panel, a driving controller driving the display panel, and an afterimage compensation unit receiving input image data from the driving controller and compensating the input image data, the afterimage compensation unit includes a modeling processing unit receiving a plurality of line data and a plurality of afterimage distribution data, and deriving an afterimage distribution prediction equation based on the plurality of line data and the plurality of afterimage distribution data, a first gain generation unit receiving the afterimage distribution prediction equation and generating a first gain which is a formalized coefficient generated by using the afterimage distribution prediction equation, a second gain generation unit receiving the input image data to generate a second gain, a compensation gain calculating unit receiving the first gain and the second gain, and generating a compensation gain based on the first gain and the second gain, and a compensation unit compensating the input image data by using the compensation gain.

### BRIEF DESCRIPTION OF THE FIGURES

FIG. 1 is a block diagram of an electronic device according to an embodiment.

FIG. 2 is a schematic diagram of an electronic device according to various embodiments of the present disclosure.

FIG. 3 is a block diagram of an electronic device according to an embodiment of the present disclosure.

FIG. 4 is a block diagram for illustrating an afterimage compensation unit according to an embodiment of the present disclosure.

FIG. 5A is a block diagram for illustrating an afterimage distribution prediction unit according to an embodiment of the present disclosure.

FIG. 5B is a diagram illustrating afterimage distribution data according to an embodiment of the present disclosure.

FIG. 6 is a block diagram for illustrating an accumulation gain generation unit according to an embodiment of the present disclosure.

FIG. 7A is a comparative example illustrating an afterimage index according to time.

FIG. 7B is a comparative example illustrating the afterimage index according to time.

FIG. 7C is an embodiment illustrating the afterimage index according to time according to an embodiment of the present disclosure.

### DETAILED DESCRIPTION

In this specification, it will be understood that when an element (or an area, a layer, a portion, or the like) is referred to as being "on", "connected to" or "coupled to" another element, it may be directly arranged on, connected to, or coupled to the other element or layer or other elements may be arranged therebetween.

Like reference numerals or symbols refer to like elements throughout. In the drawings, the thickness, ratio, and size of the elements are exaggerated for effectively describing the technical contents. The term "and/or" includes any and all combinations of one or more of the associated listed elements.

It will be understood that, although the terms “first”, “second”, etc. may be used herein to describe various elements, the elements are not to be limited by these terms. These terms are only used to distinguish one element from another element. For instance, a first element discussed below could be termed a second element without departing from the scope of the present disclosure. Similarly, a second element could be termed a first element. In this specification, the singular expressions "a", "an" and "the" are intended to include the plural forms as well, unless the context clearly indicates otherwise.

In addition, the terms "below", “under”, "on the lower side", "above", “over”, "on the upper side", or the like may be used to describe the relationships between the elements illustrated in the drawings. These terms are relative concepts and are described on the basis of the directions indicated in the drawings.

It will be further understood that the terms "comprises, includes, has" and/or "comprising, including, having", when used in this specification, specify the presence of stated features, numbers, steps, operations, elements, components, or combinations thereof, but do not preclude the possibility of the presence or addition of one or more other features, numbers, steps, operations, elements, components, and/or combinations thereof.

The terms “part” and “unit” mean a software component or a hardware component that performs a specific function. Hardware components may include, for example, FPGAs (field-programmable gate arrays) or ASICs (application-specific integrated circuits). A software component may refer to executable code and/or data used by executable code in an addressable storage medium. Software elements may thus be, for example, object-oriented software elements, class elements, and task elements, and may include processes, functions, attributes, procedures, subroutines, program code segments, drivers, firmware, micro-codes, circuits, data, databases, data structures, tables, arrangements, or variables.

Unless otherwise defined, all terms (including technical and scientific terms) used herein have the same meaning as commonly understood by one of ordinary skills in the art to which the present disclosure belongs. It will be further understood that terms, such as those defined in commonly used dictionaries, should be interpreted as having a meaning that is consistent with their meaning in the context of the relevant art and will not be interpreted in an idealized or overly formal detect unless expressly so defined herein.

Hereinafter, embodiments of the present disclosure are described with reference to the drawings.

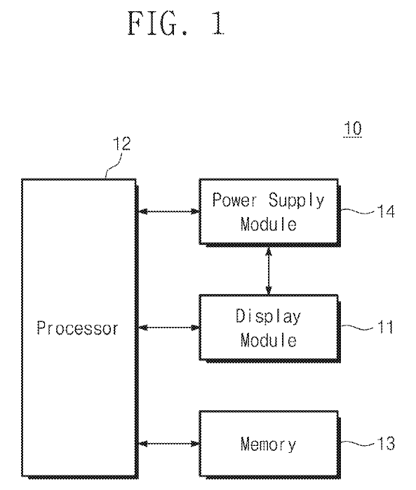

FIG. 1 is a block diagram of an electronic device 10 according to an embodiment.

Referring to FIG. 1, the electronic device 10 according to the embodiment may include a display module 11, a processor 12, a memory 13, and a power supply module 14.

The display module 11 may display an image. The image may include a still image as well as a dynamic image. The processor 12 may include at least one of a CPU (central processing unit), an AP (application processor), a GPU (graphics processing unit), a CP (communication processor), an ISP (image signal processor), and a controller. The processor 12 may be configured to control an operation of the display module 11.

The memory 13 may store data information necessary for an operation of the processor 12 and/or the display module 11. When the processor 12 executes an application stored in the memory 13, an image data signal and/or an input control signal is/are transmitted to the display module 11, and then the display module 11 may process the provided signal and output image information through a display screen.

The power supply module 14 may include a power supply module such as a power adapter or a battery device, and a power conversion module converting power supplied by the power supply module to generate power necessary for an operation of the electronic device 10.

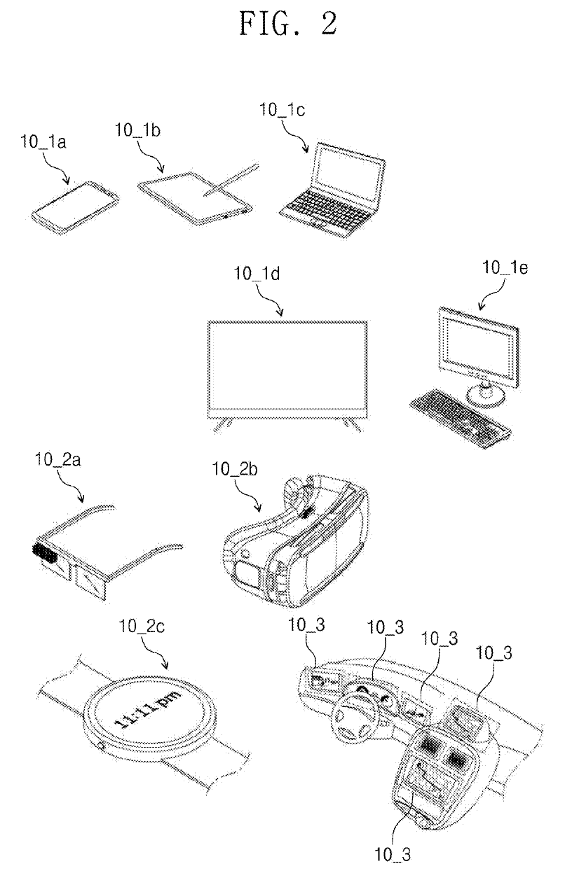

FIG. 2 is a schematic diagram of an electronic device according to various embodiments of the present disclosure.

Referring to FIG. 2, various electronic devices to which a display device according to the embodiments is applied may include an electronic device for image display such as a smartphone 10_1a, a tablet PC 10_1b, a laptop 10_1c, a TV 10_1d, a desk monitor 10_1e, and the like, as well as a wearable electronic device including a display module such as smart glasses 10_2a, a head-mounted display 10_2b, a smart watch 10_2c, and the like, and a vehicle electronic device 10_3 including a display module, such as a CID (Center Information Display) disposed on an instrument panel, a center fascia, and a dashboard of an automobile, a room mirror display, and the like.

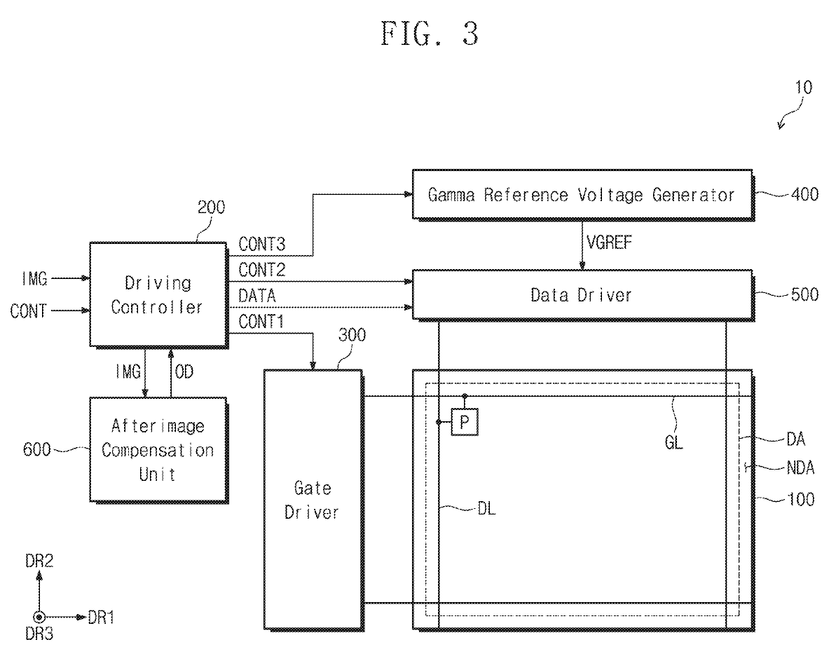

FIG. 3 is a block diagram of an electronic device 10 according to an embodiment of the present disclosure.

Referring to FIG. 3, the electronic device 10 may include a display panel 100, a driving controller 200, a gate driver 300, a gamma reference voltage generator 400, a data driver 500, and an afterimage compensation unit 600.

The display panel 100 may include a display area DA and a non-display area NDA. In an embodiment, the display area DA has a rectangular shape, while the present disclosure is not limited thereto. The non-display area NDA may have a frame shape surrounding the display area DA.

The display panel 100 includes a plurality of pixels P, and the pixels P may be arranged in the display area DA. The pixels P may be arranged in a first direction DR1 and a second direction DR2.

Each of the pixels P may include a light-emitting element and a pixel circuit controlling light emission of the light-emitting element. The pixel circuit may include one or more transistors and one or more capacitors. The each of the pixels P may be electrically connected with one data line and one gate line. However, the present disclosure is not limited thereto, and the each of the pixels P may be electrically connected to a plurality of gate lines.

The driving controller 200 may receive input image data IMG and an input control signal CONT from outside. For example, the input image data IMG received from the external device may include red image data, green image data, and blue image data. According to an embodiment, the input image data IMG may further include white image data. Alternatively, the input image data IMG may include magenta image data, yellow image data, and cyan image data. The input control signal CONT received from the external device may include a master clock signal, a data enable signal, a vertical synchronization signal, a horizontal synchronization signal, and the like.

The driving controller 200 may generate a first control signal CONT1, a second control signal CONT2, a third control signal CONT3, and a data signal DATA based on the input image data IMG and the input control signal CONT.

The driving controller 200 may generate a first control signal CONT1 for controlling an operation of the gate driver 300 based on the input control signal CONT to output the first control signal CONT1 to the gate driver 300. The first control signal CONT1 may include a vertical initiation signal and a gate clock signal.

The driving controller 200 may generate the second control signal CONT2 for controlling an operation of the data driver 500 based on the input control signal CONT to output the second control signal CONT2 to the data driver 500. The second control signal CONT2 may include a horizontal initiation signal and a load signal.

The driving controller 200 may generate the data signal DATA based on the input image data IMG. For example, the data signal DATA may be a signal obtained by converting a data format of the input image data IMG to comply with an interface specification of the data driver 500. The driving controller 200 may output the generated data signal DATA to the data driver 500.

The driving controller 200 may generate the third control signal CONT3 for controlling an operation of the gamma reference voltage generator 400 based on the input control signal CONT. The driving controller 200 may output the generated third control signal CONT3 to the gamma reference voltage generator 400.

The gate driver 300 may generate gate signals for driving the gate lines GL in response to the first control signal CONT1 received from the driving controller 200. The gate driver 300 may output the generated gate signals to the gate lines GL. For example, the gate driver 300 may sequentially output gate signals to the gate lines GL. According to an embodiment, the gate driver 300 may be mounted on a periphery of the display panel 100. In an embodiment, the gate driver 300 may be formed on the display panel 100 through the same process as a process forming the pixel circuit of the each of the pixels P.

The gamma reference voltage generator 400 may generate a gamma reference voltage VGREF in response to the third control signal CONT3 received from the driving controller 200. The gamma reference voltage generator 400 may provide the generated gamma reference voltage VGREF to the data driver 500. The gamma reference voltage VGREF provided to the data driver 500 may have a value corresponding to each data signal DATA. According to an embodiment, the gamma reference voltage generator 400 may be disposed in the driving controller 200 or disposed in the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA in a digital form into a data voltage in an analog form using the gamma reference voltage VGREF. The data driver 500 may output the data voltage to the data lines DL.

The data driver 500 may be implemented as an IC (integrated circuit) and mounted directly on the non-display area NDA of the display panel 100, or may be mounted on a separate printed circuit board in a COF (chip on film) manner and electrically connected to the display panel 100. In an embodiment, the driving controller 200 and the data driver 500 may be configured as separate chips that are separate from each other, or the driving controller 200 and the data driver 500 may both be included in one chip. In an embodiment, the data driver 500 may be formed on the display panel 100 through the same process as the process forming the pixel circuit of the each of the pixels P.

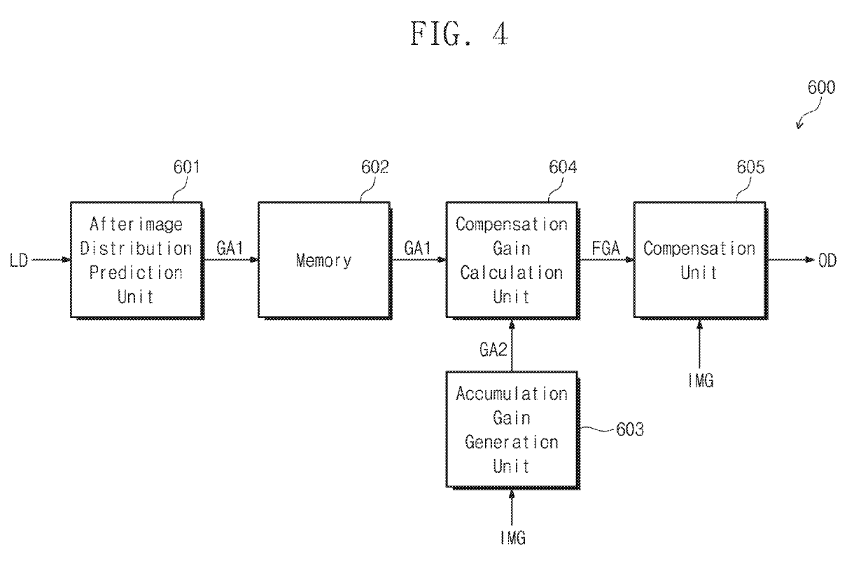

The afterimage compensation unit 600 may receive the input image data IMG from the driving controller 200 and may receive a plurality of line data LD (see FIG. 4) from the outside. Alternatively, the afterimage compensation unit 600 may receive the input image data IMG from the outside.

In an embodiment of the present disclosure, the line data LD (see FIG. 4) may be data collected during a manufacturing process of the electronic device 10 before the electronic device 10 is completed. For example, the line data LD (see FIG. 4) may include fabrication line data or module line data. The fabrication line data may mean data (e.g., characteristic data of the display panel) collected in a manufacturing process step of the display panel 100, and the fabrication line data may include information about a threshold voltage of a transistor, a feature depending on the arrangement of the pixels, a voltage value (data range) for outputting the same current, and the like. In addition, the module line data may mean data (e.g., characteristic data of the display panel or the electronic device) collected in a product assembly step after the completion of the display panel 100, and the module line data may include information about current consumption, voltage, current, luminance, leakage current, transistor characteristics, and the like.

In an embodiment of the present disclosure, the afterimage compensation unit 600 may generate a compensation image date based on the input image data IMG and the line data LD (see FIG. 4) to compensate for the input image data IMG. In an embodiment, the afterimage compensation unit 600 may compensate for the input image data IMG to compensate for a medium-term afterimage. However, the present disclosure is not limited thereto, and the afterimage compensation unit 600 may compensate for a short-term or a long-term afterimage by compensating for the input image data IMG. The medium-term afterimage may be an afterimage generated when the same image, for example, a still image, is displayed for a long time. The short-term afterimage may be an instantaneous afterimage of high luminance, and the long-term afterimage may be an afterimage due to deterioration. However, this is only an example and this disclosure is not particularly limited thereto.

The afterimage compensation unit 600 may compensate the input image data IMG by using the compensation coefficient generated in the afterimage compensation unit 600, and then output the compensated data as compensation image data OD to the driving controller 200.

An arrangement of the afterimage compensation unit 600 in FIG. 3 is an example according to an embodiment of the present disclosure. According to an embodiment, the afterimage compensation unit 600 may be disposed in the driving controller 200 and may be a part of the driving controller 200, or may be disposed outside the driving controller 200 to receive data from and supply data to the driving controller 200. In addition, the afterimage compensation unit 600 may be disposed in the data driver 500 and may be a part of the data driver 500, or may be disposed outside the data driver 500 to receive data from and supply data to the data driver 500.

FIG. 4 is a block diagram for illustrating an afterimage compensation unit 600 according to an embodiment of the present disclosure.

Referring to FIGS. 3 and 4, the afterimage compensation unit 600 may include an afterimage distribution prediction unit 601, a memory 602, an accumulation gain generation unit 603, a compensation gain calculation unit 604, and a compensation unit 605.

The afterimage distribution prediction unit 601 may receive the line data LD. The afterimage distribution prediction unit 601 may predict afterimage distribution based on the received line data LD. In an embodiment, the afterimage distribution prediction unit 601 may predict afterimage distribution by using line data LD and data obtained by measuring an afterimage of a module. For example, the afterimage distribution prediction unit 601 may construct large-scale big data based on the line data LD and the data obtained by measuring the afterimage of the module, and predict the afterimage distribution by modeling big data to derive an afterimage distribution prediction equation. The afterimage of the module may be an afterimage of the display module 11 (see FIG. 1) or the display panel 100 which will be described below as the display panel 100.

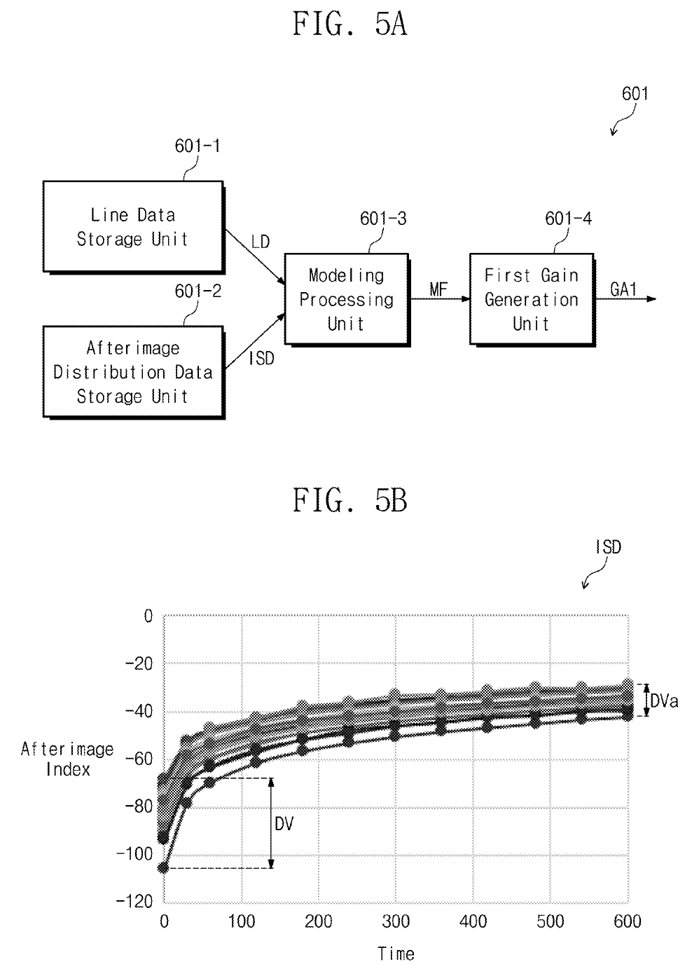

In an embodiment of the present disclosure, the afterimage distribution prediction unit 601 may generate a first compensation coefficient GA1 for compensating for an afterimage based on the predicted afterimage distribution. The afterimage distribution prediction unit 601 may output the generated first compensation coefficient GA1 to the memory 602. In this specification, the first compensation coefficient GA1 may be referred to as a first gain GA1. Below, the afterimage distribution prediction unit 601 will be described in detail with reference to FIGS. 5A and 5B.

The memory 602 may receive the first compensation coefficient GA1 from the afterimage distribution prediction unit 601. The received first compensation coefficient GA1 may be stored in the memory 602. In an embodiment, the memory 602 may be a NVM (non-volatile memory). For example, the memory 602 may be NAND flash memory, NOR flash memory, EEPROM, MRAM, FRAM, or the like.

The accumulation gain generation unit 603 may receive the input image data IMG from the outside. In addition, the accumulation gain generation unit 603 may receive the input image data IMG from the driving controller 200. The accumulation gain generation unit 603 may generate a second compensation coefficient GA2 based on the received input image data IMG. In an embodiment, the input image data IMG may include information about a temperature, a maximum luminance, a duty ratio, a voltage frequency, and the like of a pixel.

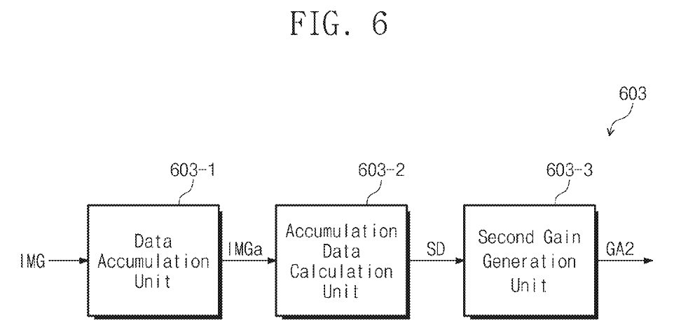

In an embodiment of the present disclosure, the accumulation gain generation unit 603 may accumulate the input image data IMG. For example, the accumulation gain generation unit 603 may accumulate stress of the input image data IMG. The accumulation gain generation unit 603 may generate the second compensation coefficient GA2 for compensating for the afterimage due to the accumulated stress. In this specification, the second compensation coefficient GA2 may be referred to as a second gain GA2 or an accumulation gain GA2. Below, the accumulation gain generation unit 603 will be described in detail with reference to FIG. 6.

The compensation gain calculation unit 604 may receive the first compensation coefficient GA1 from the memory 602, and receive the second compensation coefficient GA2 from the accumulation gain generation unit 603. The compensation gain calculation unit 604 may generate the third compensation coefficient FGA based on the first compensation coefficient GA1 and the second compensation coefficient GA2. In this specification, the third compensation coefficient FGA may be referred to as a third gain FGA, a compensation gain FGA, or a final compensation gain FGA.

In an embodiment of the present disclosure, the compensation gain calculation unit 604 may generate the third compensation coefficient FGA with reference to the first compensation coefficient GA1 based on the second compensation coefficient GA2 for compensating for the afterimage due to the accumulated stress. For example, when the second compensation coefficient GA2 is 0.5, the third compensation coefficient FGA may be 0.4 if the first compensation coefficient GA1 is less than an average value, and the third compensation coefficient FGA may be 0.6 if the first compensation coefficient GA1 is greater than or equal to the average value. However, the present disclosure is not limited thereto, and, in an embodiment, the compensation gain calculation unit 604 may generate the third compensation coefficient FGA by multiplying the first compensation coefficient GA1 and the second compensation coefficient GAb. Further, in an embodiment, the third compensation coefficient FGA may be generated in a manner different from the manner described above.

The compensation unit 605 may receive the input image data IMG from the outside, and receive the third compensation coefficient FGA from the compensation gain calculation unit 604. Alternatively, the compensation unit 605 may receive the input image data IMG from the driving controller 200. In addition, the compensation unit 605 may receive the input image data IMG from different compensation units disposed outside of the afterimage compensation unit 600. For example, the different compensation units disposed outside of the afterimage compensation unit 600 may include a panel loading compensation unit, an optical compensation unit, or the like.

The compensation unit 605 may compensate the input image data IMG by using the third compensation coefficient FGA. That is, the compensation unit 605, by compensating the input image data IMG using the third compensation coefficient FGA, may compensate for the afterimage due to the stress applied to the display panel 100.

The compensation unit 605 may output the compensated input image data IMG as the compensation image data OD to the driving controller 200.

According to the present disclosure, the afterimage compensation unit 600 may generate the final compensation gain FGA by using the first compensation coefficient GA1 based on the line data LD and the data obtained by measuring the afterimage of the display panel 100 and the second compensation coefficient GA2 based on the stress of the input image data IMG.

Even when a plurality of display panels are provided with the same input image data IMG, there may be a difference in the afterimage index of each display panel. According to the present disclosure, the afterimage compensation unit 600 may consider the line data LD for each display panel 100 and the data obtained by actually measuring the afterimage of the each display panel 100 together, so that an afterimage compensation performance of the electronic device 10 may be improved.

FIG. 5A is a block diagram for illustrating an afterimage distribution prediction unit 601 according to an embodiment of the present disclosure. FIG. 5B is a diagram illustrating afterimage distribution data ISD according to an embodiment of the present disclosure.

Referring to FIGS. 3, 4, and 5A, the afterimage distribution prediction unit 601 may include a line data storage unit 601-1, an afterimage distribution data storage unit 601-2, a modeling processing unit 601-3, and a first gain generation unit 601-4.

Line data LD including fabrication line data and module line data collected in a manufacturing process step may be stored in the line data storage unit 601-1. The fabrication line data may include the information about the threshold voltage of the transistor, the feature depending on the arrangement of the pixels, the voltage value for outputting the same current, and the like, and the module line data may include the information about the current consumption, the voltage, the current, the luminance, the leakage current, the transistor characteristics, and the like.

Referring to FIG. 5B together, afterimage distribution data ISD may be stored in the afterimage distribution data storage unit 601-2. The afterimage distribution data ISD may be data obtained by measuring an afterimage of the each of a plurality of display panels subjected to the same stress.

In an embodiment, the afterimage distribution data ISD may include information on the afterimage index according to time t. The afterimage index indicates the degree of afterimage, and the greater the absolute value of the afterimage index, the greater the degree of afterimage may be. According to the afterimage distribution data ISD illustrated in FIG. 5B, the afterimage index of the each of the display panels corresponding to the same time may be different. In addition, the difference in the afterimage index may be different from each other according to time. For example, the difference DV between the maximum value and the minimum value of an afterimage index corresponding to 0 seconds and the difference DVa between the maximum value and the minimum value of an afterimage index corresponding to 600 seconds may be different. Thus, even when the same stress is applied to the each of a plurality of display panels, the degree of afterimage due to the stress may be different for each display panel 100.

The modeling processing unit 601-3 may receive the line data LD from the line data storage unit 601-1 and receive the afterimage distribution data ISD from the afterimage distribution data storage unit 601-2. The modeling processing unit 601-3 may convert the received line data LD and the received afterimage distribution data ISD into the big data. In addition, the modeling processing unit 601-3 may model the big data to derive the afterimage distribution prediction equation MF for outputting the afterimage distribution prediction equation MF to the first gain generation unit 601-4. For example, the modeling processing unit 601-3 may apply a machine learning and statistical analysis technique by utilizing the big data, and learn a pattern of the afterimage distribution to generate a prediction model. As a result, the afterimage distribution prediction equation MF that predicts how the afterimage for each display panel 100 occurs and is distributed may be derived. When the afterimage distribution prediction equation MF according to the present disclosure is derived, the display quality of the electronic device 10 including the afterimage compensation unit 600 may be improved by optimizing an afterimage compensation algorithm and establishing a pre-corresponding system capable of pre-compensating for the afterimage before the afterimage occurs.

The first gain generation unit 601-4 may receive the afterimage distribution prediction equation MF from the modeling processing unit 601-3. The first gain generation unit 601-4 may generate a first compensation coefficient GA1 for compensating for the afterimage based on the received afterimage distribution prediction equation MF. In an embodiment, the first compensation coefficient GA1 is a formalized coefficient generated by using the afterimage distribution prediction equation MF, and may be differentially generated according to afterimage characteristics of each display panel 100. For example, a weight of the first compensation coefficient GA1 may increase for the display panel 100 with a large afterimage distribution, and the weight of the first compensation coefficient GA1 may decrease for the display panel with a small afterimage distribution.

According to the present disclosure, since the afterimage compensation unit 600 applies different first compensation coefficients GA1 to the display panels 100, different compensation values may be applied to each display panel 100 even when the same input image data IMG is received. That is, instead of applying a same compensation value to the display panels 100 with different afterimage characteristics, different compensation values generated by actual measurement for each display panel 100 may be applied to each display panel 100. Therefore, an afterimage compensation performance of the electronic device 10 may be improved.

FIG. 6 is a block diagram for illustrating an accumulation gain generation unit 603 according to an embodiment of the present disclosure.

Referring to FIGS. 4 and 6, the accumulation gain generation unit 603 may include a data accumulation unit 603-1, an accumulation data calculation unit 603-2, and a second gain generation unit 603-3.

The data accumulation unit 603-1 may receive the input image data IMG. The data accumulation unit 603-1 may accumulate the received input image data IMG. For example, the data accumulation unit 603-1 may accumulate the stress of the received input image data IMG. The input image data IMG may include the information about the temperature, the maximum luminance, the duty ratio, the voltage frequency, and the like of the pixel, and the data accumulation unit 603-1 may accumulate the stress due to the input image data IMG including the information. The data accumulation unit 603-1 may generate accumulation data IMGa obtained by accumulating the stress to output the accumulation data IMGa to the accumulation data calculation unit 603-2.

The accumulation data calculation unit 603-2 may receive the accumulation data IMGa from the data accumulation unit 603-1. The accumulation data calculation unit 603-2 may calculate a stress sum value SD included in the accumulation data IMGa. That is, the accumulation data calculation unit 603-2 may calculate a total stress sum value SD of the data accumulated in the data accumulation unit 603-1, and the stress sum value SD may have different values for each input image data IMG. Below, the stress sum value SD may be referred to as stress data SD. The accumulation data calculation unit 603-2 may output the stress data SD to the second gain generation unit 603-3.

The second gain generation unit 603-3 may receive the stress data SD from the accumulation data calculation unit 603-2. The second gain generation unit 603-3 may generate a second compensation coefficient GA2 corresponding to the stress data SD. For example, the second gain generation unit 603-3 may generate a second compensation coefficient GA2 for compensating for the stress included in the stress data SD. In an embodiment, a manner of generating the second compensation coefficient GA2 corresponding to the stress data SD may be stored in the second gain generation unit 603-3 in advance. In addition, in an embodiment, a manner of generating the second compensation coefficient GA2 corresponding to the stress data SD may be stored in an external memory and provided to the second gain generation unit 603-3. Therefore, the second gain generation unit 603-3 may generate the second compensation coefficient GA2 according to the input stress data SD in real time.

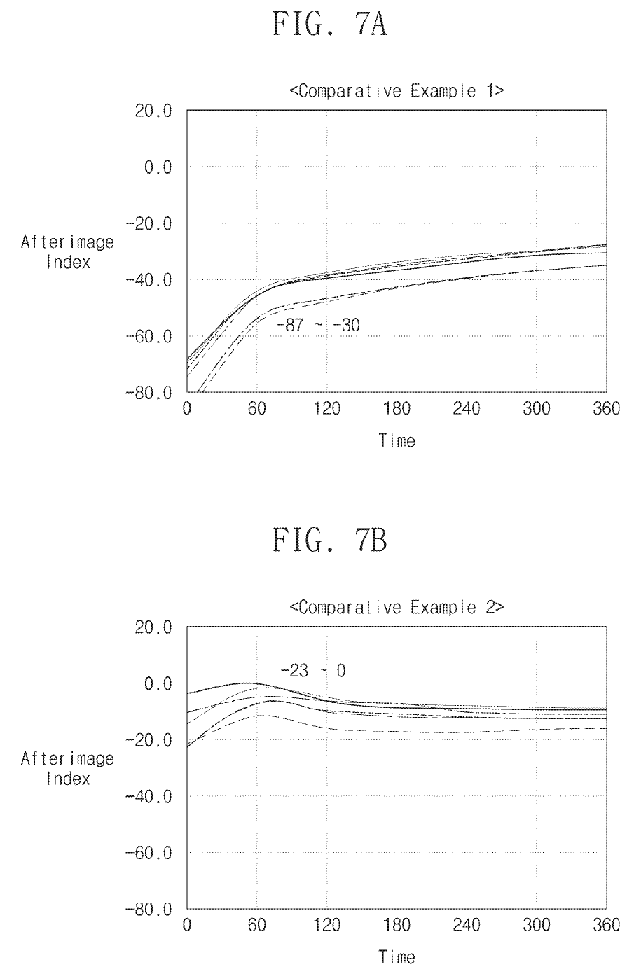

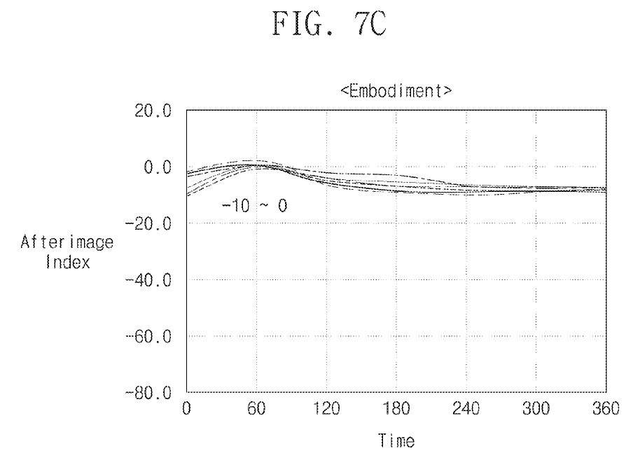

FIG. 7A is a comparative example illustrating an afterimage index according to time. FIG. 7B is a comparative example illustrating the afterimage index according to time. FIG. 7C is an embodiment of the present disclosure illustrating the afterimage index according to time.

FIG. 7A is the comparative example illustrating the afterimage index before compensating for the afterimage of the each of the plurality of display panels, FIG. 7B is the comparative example indicating the afterimage index when the afterimage is compensated for based only on input image data IMG (see FIG. 4) of the each of the plurality of the display panels, and FIG. 7C is the embodiment illustrating the afterimage index when the afterimage is compensated based on the line data LD (see FIG. 4), the afterimage distribution data ISD (see FIG. 5), and the input image data IMG (see FIG. 3) of the each of the plurality of display panels according to the embodiment of the present disclosure. The comparative example of FIG. 7A is illustrated as Comparative Example 1, and the comparative example of FIG, 7B is illustrated as Comparative example 2.

Referring to FIG. 7A, the afterimage index of the each of the plurality of display panels before compensating for the afterimage may be between −87 and −30, and may have an afterimage index with a large absolute value.

Referring to FIG. 7B, an afterimage index when an afterimage is compensated based only on the input image data IMG (see FIG. 4) of the each of the plurality of display panels may be between −23 and 0, which is reduced in absolute value compared to FIG. 7A, but may still have an afterimage index with a large absolute value.

Referring to FIG. 7C according to the present disclosure, an afterimage index when an afterimage is compensated based on the line data LD (see FIG. 4), the afterimage distribution data ISD (see FIG. 5), and the input image data IMG (see FIG. 4) of the each of the plurality of display panels may be between −10 and 0, which has an afterimage index with a small absolute value compared to FIGS. 7A and 7B. In addition, in FIG. 7C, deviation of the graphs of the each of the plurality of display panels may be small compared to FIGS. 7A and 7B.

Thus, in the case where the afterimage is compensated using all of the line data LD (see FIG. 4), the afterimage distribution data ISD (see FIG. 5), and the input image data IMG (see FIG. 4) of the each of the plurality of display panels according to the present disclosure, the afterimage compensation performance may be improved as compared with the case where the afterimage are compensated using some of the line data LD (see FIG. 4), the afterimage distribution data ISD (see FIG. 5), and the input image data IMG (see FIG. 4).

As described above, the afterimage compensation unit may generate the first compensation coefficient based on the line data for each display panel and the data obtained by actually measuring the afterimage of the display panel, and may generate the second compensation coefficient based on the stress of the input image data. The afterimage compensation unit may generate the third compensation coefficient by using the first compensation coefficient and the second compensation coefficient. Accordingly, even when the same input image data are provided to the plurality of display panels, the afterimage compensation unit may apply different compensation values for each display panel by referring to the line data for each display panel and the data obtained by actually measuring the afterimage of the display panel together. As a result, the afterimage compensation performance of the electronic device may be improved.

While the preferred embodiments of the present disclosure have been described above, it will be understood by those skilled in the art that various modifications and changes may be made to the present disclosure without departing from the spirit and technical scope of the present disclosure as set forth in the following claims.

Therefore, the technical scope of the present disclosure should not be limited to the content stated in the detailed description of the specification, but should be determined by the claims.

What is claimed is:

1. An electronic device comprising:
a display panel; and
an afterimage compensation unit receiving input image data from an outside and compensating the input image data,
wherein the afterimage compensation unit includes,
an afterimage distribution prediction unit receiving a plurality of line data to predict afterimage distribution and generating a first compensation coefficient based on predicted afterimage distribution;
an accumulation gain generation unit receiving the input image data to generate a second compensation coefficient;
a compensation gain calculation unit receiving the first compensation coefficient and the second compensation coefficient, and generating a third compensation coefficient based on the first compensation coefficient and the second compensation coefficient; and
a compensation unit receiving the input image data and the third compensation coefficient, and compensating the input image data by using the third compensation coefficient to generate compensation image data.

2. The electronic device of claim 1, wherein the plurality of line data are data collected during a manufacturing process.

3. The electronic device of claim 2, wherein the plurality of line data include fabrication line data or module line data.

4. The electronic device of claim 1, wherein the afterimage compensation unit further includes a memory in which the first compensation coefficient is stored.

5. The electronic device of claim 4, wherein the memory is a non-volatile memory.

6. The electronic device of claim 1, wherein the afterimage distribution prediction unit includes,
a modeling processing unit deriving an afterimage distribution prediction equation based on the plurality of line data and a plurality of afterimage distribution data; and
a first gain generation unit receiving the afterimage distribution prediction equation and generating the first compensation coefficient which is a formalized coefficient generated by using the afterimage distribution prediction equation.

7. The electronic device of claim 6, wherein the modeling processing unit converts the plurality of line data and the plurality of afterimage distribution data into big data.

8. The electronic device of claim 7, wherein the modeling processing unit models the big data to derive the afterimage distribution prediction equation.

9. The electronic device of claim 6, wherein the plurality of afterimage distribution data include information about an afterimage index according to time.

10. The electronic device of claim 6, wherein the afterimage distribution prediction unit further includes,
a line data storage unit storing the plurality of line data; and
an afterimage distribution data storage unit storing the plurality of afterimage distribution data.

11. The electronic device of claim 1, wherein the accumulation gain generation unit includes,
a data accumulation unit receiving the input image data and generating accumulation data which includes accumulated stress of the input image data;
an accumulation data calculation unit calculating a stress sum value of the accumulation data; and
a second gain generation unit generating the second compensation coefficient corresponding to the stress sum value.

12. The electronic device of claim 11, wherein the second gain generation unit generates the second compensation coefficient according to the stress sum value in real time.

13. An electronic device driving method, comprising:
receiving a plurality of line data and predicting afterimage distribution based on the plurality of line data;
generating a first compensation coefficient for compensating an afterimage based on predicted afterimage distribution;
receiving input image data from an outside and accumulating stress of the input image data;
generating a second compensation coefficient for compensating an afterimage due to the accumulated stress;
generating a third compensation coefficient based on the first compensation coefficient and the second compensation coefficient; and
compensating the input image data by using the third compensation coefficient.

14. The electronic device driving method of claim 13, further comprising:
storing the first compensation coefficient in a memory.

15. The electronic device driving method of claim 13, wherein the predicting the afterimage distribution includes,
deriving an afterimage distribution prediction equation based on the plurality of line data and a plurality of afterimage distribution data; and
receiving the afterimage distribution prediction equation and generating the first compensation coefficient which is a formalized coefficient generated by using the afterimage distribution prediction equation.

16. The electronic device driving method of claim 15, wherein the deriving the afterimage distribution prediction equation includes converting the plurality of line data and the plurality of afterimage distribution data into big data.

17. The electronic device driving method of claim 16, wherein the deriving the afterimage distribution prediction equation further includes modeling the big data to derive the afterimage distribution prediction equation.

18. The electronic device driving method of claim 15, wherein the plurality of afterimage distribution data include information about an afterimage index according to time.

19. The electronic device driving method of claim 13, wherein the plurality of line data are data collected during a manufacturing process.

20. An electronic device comprising:
a display panel;
a driving controller driving the display panel; and
an afterimage compensation unit receiving input image data from the driving controller and compensating the input image data,
wherein the afterimage compensation unit includes,
a modeling processing unit receiving a plurality of line data and a plurality of afterimage distribution data, and deriving an afterimage distribution prediction equation based on the plurality of line data and the plurality of afterimage distribution data;
a first gain generation unit receiving the afterimage distribution prediction equation and generating a first gain which is a formalized coefficient generated by using the afterimage distribution prediction equation;
a second gain generation unit receiving the input image data to generate a second gain;
a compensation gain calculating unit receiving the first gain and the second gain, and generating a compensation gain based on the first gain and the second gain; and
a compensation unit compensating the input image data by using the compensation gain.
